(19) United States
(12) Patent Application Publication
(10) Pub. No.: US 2025/0130774 A1
(43) Pub. Date: Apr. 24, 2025

(54) FLOATING POINT BIAS SWITCHING

(71) Applicant: Advanced Micro Devices, Inc., Santa Clara, CA (US)

(72) Inventors: Shubh Shah, Santa Clara, CA (US); Ashutosh Garg, Folsom, CA (US); Bin He, Orlando, FL (US); Michael Mantor, Orlando, FL (US); Shubra Marwaha, Santa Clara, CA (US); Subramaniam Maiyuran, Folsom, CA (US)

(73) Assignee: Advanced Micro Devices, Inc., Santa Clara, CA (US)

(21) Appl. No.: 18/395,190

(22) Filed: Dec. 22, 2023

Related U.S. Application Data
(60) Provisional application No. 63/591,962, filed on Oct. 20, 2023.

(51) Int. Cl. G06F 7/556; G06F 7/483

(52) U.S. Cl. CPC G06F 7/556; G06F 7/483

(57) ABSTRACT

The disclosed circuit can interpret a bit sequence as a value based on one of multiple floating point number formats in a bias mode indicated by a bias mode indicator. The circuit can and perform an operation using the value in the bias mode. Various other methods, systems, and computer-readable media are also disclosed.

### CROSS REFERENCE TO RELATED APPLICATION

This application claims the benefit of U.S. Provisional Application No. 63/591,962, filed 20 Oct. 2023, the disclosure of which is incorporated, in its entirety, by this reference.

### BACKGROUND

Floating point numbers are commonly used by computing devices to represent a wide range of real number values for computations. Different floating point number formats can be configured for various considerations, such as storage space/bandwidth considerations, computational considerations, mathematical properties, etc. Further, different computing devices can be configured to support different formats of floating point numbers. As computing devices become more complex (e.g., having different types of hardware working in conjunction, using networked devices, etc.), and computing demands increase (e.g., by implementing machine learning models, particularly for fast decision making), support for different floating point number formats can be desirable. Although software-based support for different floating point number formats is possible, software support often incurs added latency or can otherwise be unfeasible for particular application requirements.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for floating point bias switching.

FIGS. 2A-C are diagrams of example floating point number formats.

FIG. 3 is a simplified block diagram of a circuit for bias mode switching.

FIG. 4 is a flow diagram of an exemplary method for floating point bias switching.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to floating point bias switching. As will be explained in greater detail below, implementations of the present disclosure interpret a bit sequence based on a bias mode indicator as applied to a floating point number format using instructions and/or circuitry. The bias mode indicator can be dynamically adjusted such that the systems and methods provided herein allow dynamic switching of the bias mode, providing flexibility and compatibility with different processor architectures. In addition, the systems and methods described herein can improve the technical field of machine learning by providing efficient processing of differently biased values, and further allowing compatibility with different local and/or remote hardware architectures.

In one implementation, a device for floating point bias switching includes a processing circuit configured to interpret a bit sequence as a value based on one of a plurality of number formats as indicated by a bias mode indicator and perform an operation using the value.

In some examples, the bias mode indicator corresponds to a status bit. In some examples, the status bit is hardware programmable. In some examples, the status bit is dynamically adjustable via software. In some examples, the device further includes a plurality of processing circuits that includes the processing circuit, wherein each of the plurality of processing circuits correspond to a respective one of the plurality of number formats.

In some examples, the processing circuit is configured to interpret an exponent using a bias in accordance with the corresponding number format and further based on the bias mode indicator. In some examples, the processing circuit is configured to interpret special bit sequences as special values in accordance with the corresponding number format.

In some examples, the device further includes a set of instructions and a corresponding bias mode indicator for each of the plurality of number formats. In some examples, each set of instructions is configured to interpret an exponent using a bias in accordance with the corresponding number format and further based on the corresponding bias mode indicator. In some examples, each set of instructions is configured to interpret special bit sequences as special values in accordance with the corresponding number format.

In some examples, each of the plurality of number formats correspond to a floating point format. In some examples, each of the floating point formats have a similar level of precision.

In one implementation, a system for floating point bias switching includes a memory, and a processing circuit configured with a set of instructions, each instruction configured to interpret a bit sequence read from the memory as a value based on one of a plurality of number formats as modified by a bias mode indicator and perform an operation using the value.

In some examples, the bias mode indicator is dynamically adjustable. In some examples, the set of instructions is configured to interpret an exponent in accordance with the corresponding number format using a bias based on the bias mode indicator. In some examples, each set of instructions is configured to interpret special bit sequences as special values in accordance with the corresponding number format using a bias based on the bias mode indicator. In some examples, each of the plurality of number formats correspond to a floating point format, each of the floating point formats having a similar level of precision.

In one implementation, a method for floating point bias switching includes (i) receiving, as part of an operation, a bit sequence corresponding to a number format, (ii) extracting a number element from the bit sequence based on the number format, (iii) applying a bias to the extracted element based on a bias mode indicator to determine a value from the bit sequence, and (iv) completing the operation using the determined value.

In some examples, the bias mode indicator is dynamically adjustable. In some examples, the number format corresponds to a floating point format and the number element corresponds to an exponent.

Features from any of the implementations described herein can be used in combination with one another in accordance with the general principles described herein. These and other implementations, features, and advantages will be more fully understood upon reading the following detailed description in conjunction with the accompanying drawings and claims.

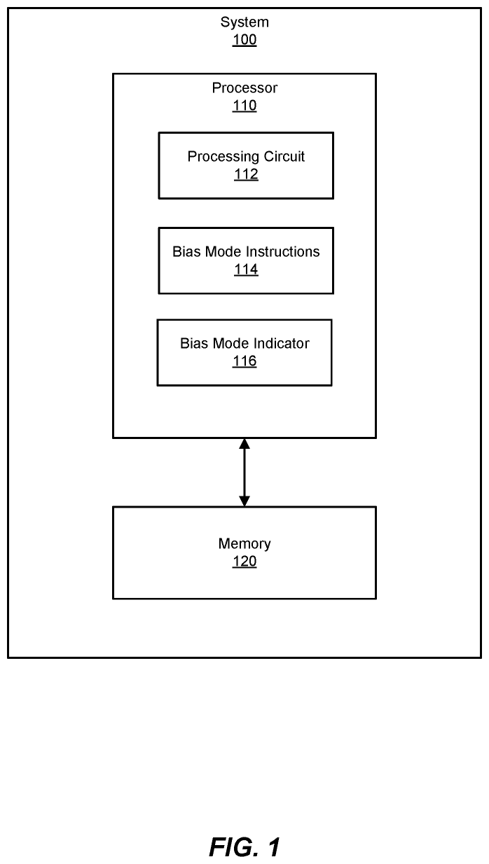

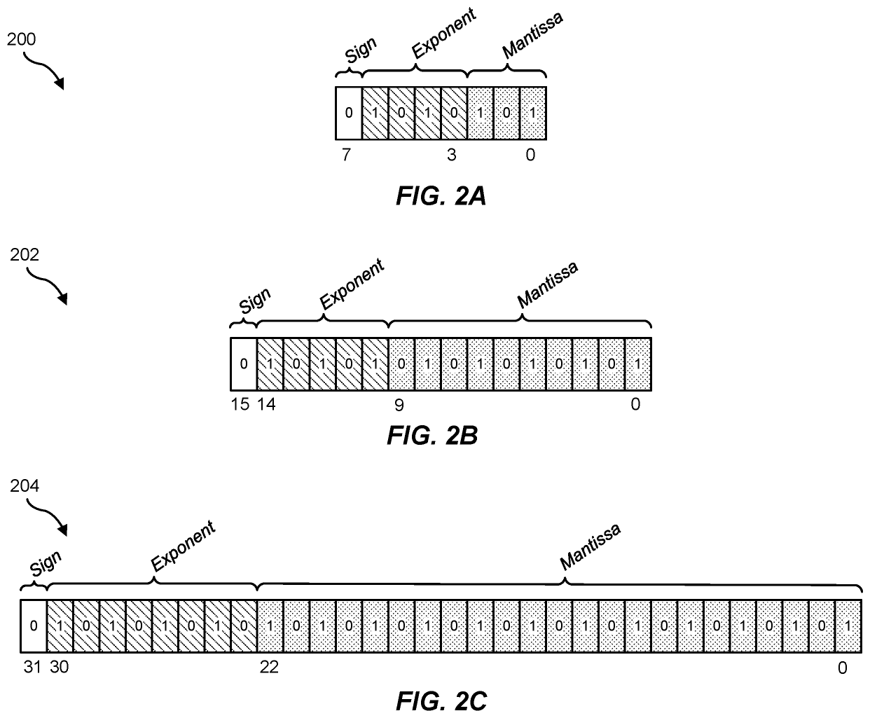

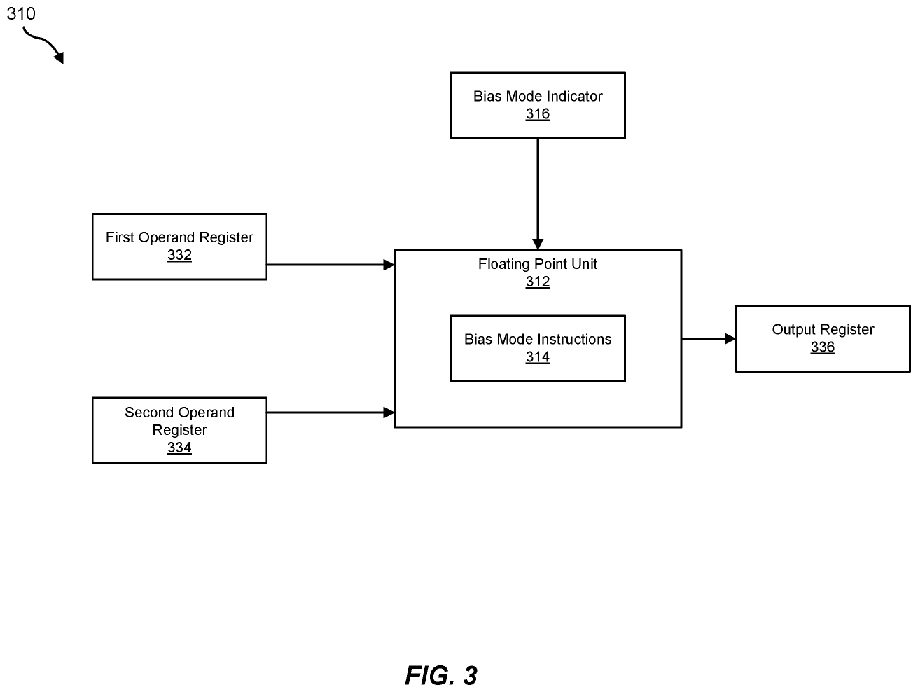

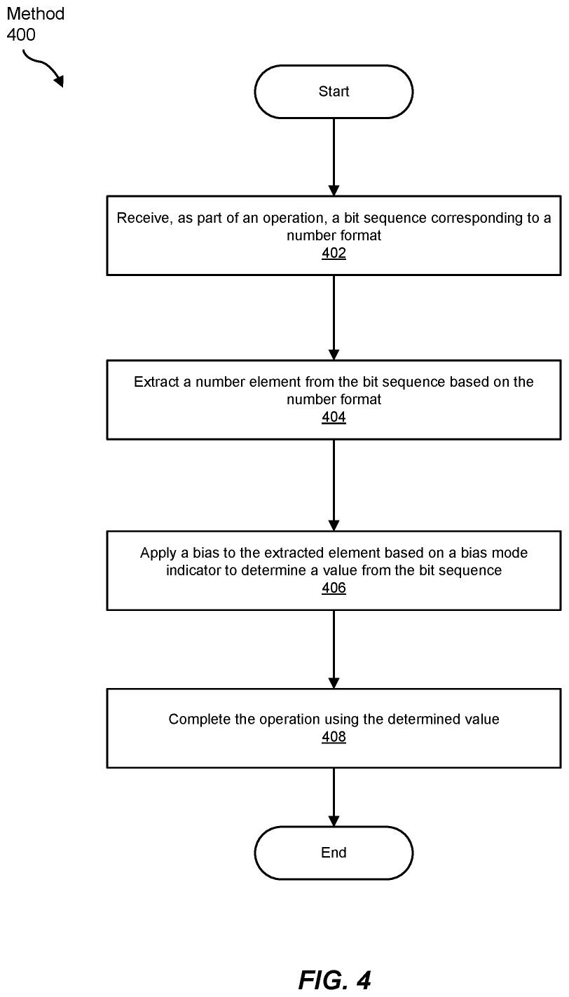

The following will provide, with reference to FIGS. 1-4, detailed descriptions of hardware-based bias mode switching. Detailed descriptions of example systems and circuits will be provided in connection with FIGS. 1 and 3. Detailed descriptions of floating point number formats will be provided in connection with FIGS. 2A-2C. Detailed descriptions of corresponding computer-implemented methods will also be provided in connection with FIG. 4.

FIG. 1 is a block diagram of an example system 100 for hardware-based floating point bias switching. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), co-processors such as digital signal processors (DSPs), Neural Network Engines (NNEs), accelerators, portions of one or more of the same, variations or combinations of one or more of the same (e.g., a host processor and a co-processor), and/or any other suitable physical processor(s).

In some implementations, the term “instruction” refers to computer code that can be read and executed by a processor. Examples of instructions include, without limitation, macro-instructions (e.g., program code that requires a processor to decode into processor instructions that the processor can directly execute) and micro-operations (e.g., low-level processor instructions that can be decoded from a macro-instruction and that form parts of the macro-instruction). In some implementations, micro-operations correspond to the most basic operations achievable by a processor and therefore can further be organized into micro-instructions (e.g., a set of micro-operations executed simultaneously).

As further illustrated in FIG. 1, processor 110 includes a processing circuit 112, bias mode instructions 114, and a bias mode indicator 116. Processing circuit 112 corresponds to a processing component and in some examples includes circuitry and/or instructions for floating point number conversion operations and/or portions thereof, and further in some examples can correspond to and/or interface with a floating point unit (FPU) for performing floating point operations. Bias mode instructions 114 correspond to circuitry and/or instructions for performing floating point operations using different biases. In some examples, bias mode instructions 114 can correspond to micro-operations that can be loaded and/or hard-wired into processing circuit 112. Bias mode indicator 116 corresponds to an indicator for selecting between possible bias modes (e.g., bias values and/or interpretation of other special values of a number format). Bias mode indicator 116 can be represented by data stored in register (e.g., a local storage of processor 110, such as for temporarily holding data for processing), a status bit stored in a flop or register, and/or other data stored in a memory device. As will be described further below, processing circuit 112 can perform floating point operations using bias mode instructions 114 that are selected and/or modified based on bias mode indicator 116.

FIGS. 2A-2C respectively illustrate a number format 200, a number format 202, and a number format 204, each corresponding to floating point formats of different precisions (e.g., bit widths). For example, FIG. 2A illustrates an example 8-bit precision floating point number format, FIG. 2B illustrates an example 16-bit precision floating point number format, and FIG. 2C illustrates an example 32-bit precision floating point number format.

A floating point number corresponds to a real number value represented with significant digits and a floating radix point. For example, a decimal (real) number 432.1 can be represented, by moving (e.g., floating) the base-10 radix point (e.g., decimal point), as 4321*10\hat{ }-1, allowing a real number value to be represented by an integer (e.g., mantissa or significand) scaled by an integer exponent of a base. Because computing systems store bit sequences which are readily converted to binary (e.g., base 2) numbers, computing systems often use a base-2 radix point. For instance, 0.5 can be represented as 1*2\hat{ }-1. Thus, in a binary representation of a floating point number, a real number value, Value, can be represented by the following equation:

$$Value = {( - 1 )}^{Sign} * Normalized\_Mantissa * {2}^{Exponent - Bias} \qquad Equation 1$$

Sign can indicate whether the value is positive (e.g., Sign=0) or negative (e.g., Sign=1). Normalized_Mantissa can correspond to a mantissa (e.g., as stored in a bit sequence) that has been normalized in accordance with a floating point number format. A non-zero binary number can have its radix point floated such that its mantissa can always have a leading 1 (e.g., “1.01”). Accordingly, many floating point number formats will not explicitly store this leading 1, as it is understood (e.g., when normalized). Exponent-Bias corresponds to the final exponent of the value after subtracting Bias from Exponent. Many floating point number formats use a bias to avoid using a sign bit (e.g., for negative exponents), which can further allow efficient processing between two floating point numbers. Thus, Exponent can correspond to the stored exponent value, and Bias can be a value defined for the specific floating point number format. Further, floating point number formats can define how bits in an allotted bit width can be decoded or interpreted. Thus, certain bits can be reserved for representing Sign, certain bits can be reserved for representing Exponent, and certain bits can be reserved for representing a Mantissa that can require normalizing.

Turning to FIG. 2A, number format 200 represents an example of an 8-bit floating point number format (e.g., having an 8-bit width or precision such as quarter-precision). Number format 200 can define what each bit position of the 8-bit format represents. As illustrated in FIG. 2A, a single bit (e.g., bit 7) can correspond to a sign bit (e.g., Sign), four bits (e.g., bits 3-6 from least to most significant bits) can correspond to an exponent (e.g., Exponent), and three bits (e.g., bits 0-2 from least to most significant bits) can correspond to a mantissa. In other number formats, a number and/or order of bits for the various elements can vary. In addition, a bias (e.g., Bias) can be defined for number format 200. For example, the bias can be 7, corresponding to exponents ranging from −6 to 7, which are derived from subtracting the bias 7 from a range of 1-14 for the four bits (leaving “0” or all 0s and “15” or all 1s for special values). The bias can be based on the number of exponent bits. In some examples, the bias allows certain bit sequences (e.g., bit sequences having the exponent being all 0, as well as other particular bit sequences such as all 0, etc.) to represent special values (e.g., subnormal values, positive/negative zero, positive/negative infinity, undefined/not a number (NaN), etc.).

FIG. 2B illustrates number format 202 that represents an example of a 16-bit floating point number format (e.g., half-precision). As illustrated in FIG. 2B, a single bit (e.g., bit 15) can correspond to a sign bit (e.g., Sign), five bits (e.g., bits 10-14 from least to most significant bits) can correspond to an exponent (e.g., Exponent), and ten bits (e.g., bits 0-9 from least to most significant bits) can correspond to a mantissa. The bias can be based on the number of exponent bits, such as 15, which can further reserve certain bit sequences as special values as described herein. In other examples, number format 202 can have different number and/or order of bits for the various elements.

FIG. 2C illustrates number format 204 that represents an examples of a 32-bit floating point number format (e.g., single-precision). As illustrated in FIG. 2C, a single bit (e.g., bit 31) can correspond to a sign bit (e.g., Sign), eight bits (e.g., bits 23-30 from least significant to most significant bits) can correspond to an exponent (e.g., Exponent), and twenty-three bits (e.g., bits 0-22 from least significant to most significant bits) can correspond to a mantissa. The bias can be based on the number of exponent bits, such as 127, which can further reserve certain bit sequences as special values as described herein. In other examples, number format 204 can have different number and/or order of bits for the various elements.

In some examples, system 100 (e.g., processor 110) can be configured with circuitry and/or instructions for particular floating point number formats. For example, certain elements of a number format (e.g., bias, special value sequences, etc.) can be incorporated into the circuitry and/or instructions without explicitly storing such elements in the floating point number (e.g., bit sequence) itself. In some implementations, processor 110 can include circuitry and/or instructions for each supported floating point number format (e.g., processing circuit 112 and/or bias mode instructions 114 can correspond to multiple iterations).

In some implementations, a bias mode can correspond to a variation of a number format that can include a different bias value (e.g., when normalizing an exponent value) as well as different interpretations of bit sequences into special values. In some examples, different bias modes for a number format can maintain certain aspects of the number format. For example, number format 204 can have different bias modes in which the sign, exponent, and mantissa bits remain unchanged, but the exponent bias as well as special bit sequences can vary for the different bias modes. Further, in some examples, a bias mode can correspond to a binary condition (e.g., corresponding to two different bias modes) such that the bias mode can correspond to one of the two options. In yet other examples, a bias mode can correspond to whether the exponent is biased (e.g., having a bias value) or non-biased (e.g., having zero or no bias value). Moreover, because the bias mode affects how numbers are represented, special bit sequences (e.g., all zeros, all ones, etc.) can be mapped to different special values (e.g., positive/negative zero, positive/negative infinity, NaN, denormalized numbers, etc.).

A bias mode affects how numbers are represented or mapped to bit sequences. Based on a type of values and/or ranges of values to be processed, different bias modes can be more appropriate. For example, one bias value can be used when only processing numbers greater than 1, another bias value can be used when only processing numbers between 0 and 1, etc. In addition, certain bias modes can be better suited for different types of processing. Accordingly, processor 110 can be configured (e.g., with instructions and/or circuitry) to use a particular bias mode of a given number format. However, in some examples, it can be desirable for processor 110 to process values in a different bias mode without incurring latency and other inefficiencies of software-based bias mode reinterpretation.

FIG. 3 illustrates a processor 310 (corresponding to processor 110), that can dynamically change bias modes for one or more number formats. FIG. 3 includes a first operand register 332 (corresponding to register), a second operand register 334 (corresponding to another register), an output register 336 (corresponding to yet another register), a floating point unit 312 (corresponding to processing circuit 112), bias mode instructions 314 (corresponding to bias mode instructions 114), and a bias mode indicator 316 (corresponding to bias mode indicator 116).

First operand register 332 and second operand register 334 can each be configured to load data (e.g., a value) in a floating point number format from one or more sources, such as a device, component, and/or portion of memory. In some examples, the first and second floating point formats can vary. Moreover, in some examples, the first and second floating point formats can correspond different number formats to a similar precision (e.g., bit width), although in other examples can correspond to different precisions.

Floating point unit 312 can perform floating point operations on the values stored in first operand register 332 and second operand register 334. Floating point unit 312 can load or otherwise be hard-wired (e.g., as circuitry) with instructions (e.g., micro-operations) for performing various floating point operations, such as arithmetic operations with floating point numbers as operands. As described herein, certain floating point number formats can have different bias modes, which can affect how values are interpreted and processed in floating point operations. Floating point unit 312 can be configured for each of the different bias modes.

When decoding a floating point operation into micro-operations, floating point unit 312 can select appropriate micro-operations (e.g., bias mode instructions 314) for the operation based on bias mode indicator 316 and the floating point number format of first operand register 332 and/or second operand register 334. In some examples, bias mode instructions 314 can include or be selected from multiple sets of micro-operations corresponding to each bias mode of one or more number formats. For example, for all of the floating point number formats that floating point unit 312 can support, each bias mode can be represented with a set of micro-operations, further applied to each supported floating point operation. Floating point unit 312 can identify the floating point number format (e.g., based on a source of the values and/or in some examples, based on identifying the registers) and select the appropriate bias mode for the identified floating point number format. Accordingly, floating point unit 312 can use an appropriate set of micro-operations (e.g., bias mode instructions 314) out of the possible options that directly use the values from first operand register 332 and second operand register 334 without requiring an intermediary conversion operation.

The set of micro-operations can include micro-operations for completing the floating point operations. In some examples, bias mode instructions 314 can include micro-operations for normalizing signs, exponents, and mantissas of the two operands (e.g., applying a corresponding bias value as needed and/or interpreting special values in accordance with the bias mode), further allowing combining the signs, exponents, and/or mantissas in accordance with the operation to produce an output result that can be stored in output register 336.

In some implementations, bias mode indicator 316 can correspond to a status bit. For instance, when two bias modes are available, a status bit (e.g., in a flop or register) can indicate which bias mode to use. In other examples having more than two bias modes, bias mode indicator 316 can include additional bits. Moreover, in some implementations, bias mode indicator 316 can be used globally (e.g., for all floating point number formats supported by floating point unit 312 having multiple bias modes) and/or restricted to particular floating point number formats such that floating point unit 312 references bias mode indicator 316 when decoding operations for only a specific set of formats.

In some examples, bias mode indicator 316 (e.g., the status bit) can be hardware programmable. For instance, bias mode indicator 316 can be saved in a non-volatile memory device, which in some implementations can be permanent, and in other implementations can be modified. In some examples, bias mode indicator 316 can be dynamically adjusted via software. For instance, a particular software application can use a particular bias mode when processing one set of data, and switch to another bias mode for processing a different set of data. Alternatively, a first software application can run in a first bias mode (setting bias mode indicator 316 as needed, either directly or via another interface such as an operating system), and a second software application can run in a second bias mode (also setting bias mode indicator 316 as needed).

FIG. 4 is a flow diagram of an exemplary computer-implemented method 400 for floating point bias switching. The steps shown in FIG. 4 can be performed by any suitable computer-executable code and/or computing system, including the circuits and systems illustrated in FIGS. 1 and/or 3. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein receive, as part of an operation, a bit sequence corresponding to a number format. For example, processing circuit 112 can receive a bit sequence (e.g., as read from memory 120 directly and/or indirectly such as through a cache) in a floating point number format (e.g., number format 200) as part of a floating point operation.

At step 404 one or more of the systems described herein extract a number element from the bit sequence based on the number format. For example, processing circuit 112 can extract a number element from the bit sequence in accordance with the floating point number format.

The systems described herein can perform step 404 in a variety of ways. In one example, processing circuit 112 can extract an exponent from the bit sequence in according with, for instance, number format 200. Processing circuit 112 can also extract other elements (e.g., sign and/or mantissa) in accordance with number format 200.

At step 406 one or more of the systems described herein apply a bias to the extracted element based on a bias indicator to determine a value from the bit sequence. For example, processing circuit 112 can apply a bias corresponding to bias mode indicator 116.

The systems described herein can perform step 406 in a variety of ways. In one example, processing circuit 112 can decode and/or load bias mode instructions 114 corresponding to the floating point operation and bias mode indicator 116. In some examples, bias mode indicator 116 is dynamically adjustable such that processing circuit 112 can reference bias mode indicator 116 when decoding each floating point operation. For instance, a software running on system 100 can dynamically update bias mode indicator 116 such that processing circuit 112 can accordingly switch bias modes as needed. In some examples, bias mode instructions 114 can include instructions for applying a bias value corresponding to bias mode indicator 116 to the extracted exponent, or otherwise interpret the bit sequence as a value in conformance with bias mode indicator 116.

At step 408 one or more of the systems described herein completing the operation using the determined value. For example, processing circuit 112 can complete the floating point operation using the determined value.

The systems described herein can perform step 408 in a variety of ways. In some examples, processing circuit 112 can use bias mode instructions 114 to complete the operation. Although method 400 illustrates step 406 and step 408, in some examples, step 406 and step 408 can be integrated as micro-operations in bias mode instructions 114. For example, bias mode instructions 114 can include micro-operations and/or circuitry for processing the bit sequence in accordance with the appropriate bias mode (e.g., without an explicit intermediary step of applying the bias). Processing circuit 112 can output a result of applying bias mode instructions 114 a result of the floating point operation.

As detailed above, floating point encoding schemes define how a particular bit sequence is interpreted into a number by hardware. Even with industry standards for certain aspects of encoding schemes, there can be variances or different schemes used by different vendors. Certain schemes can lack standards, for instance FP8, such that different vendors can use different biases. The different biases can provide different advantages/drawbacks, but systems are often compatible with only one bias.

The systems and methods described herein allows the capability of on-the-fly switching between two modes (which are not necessarily hardware enforced and thus allows software-based switching), to using (and be compatible with) two different biases. Thus, the systems and methods described herein provides hardware supporting both bias modes, and further provides a selectable or programmable way to select between two different bias modes, for example via a software interface. Compatibility can be achieved through instruction granularity for interpreting, for example, NAN, infinity, (positive/negative) zero, mantissa requirements, etc. This compatibility advantageously allows interfacing with systems and/or software using either of the two biases. Further, the systems and methods described herein allows using the advantages of either bias mode as needed, allowing selective use of one bias mode over the other as needed for a particular application

As detailed above, the computing devices and systems described and/or illustrated herein broadly represent any type or form of computing device or system capable of executing computer-readable instructions. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a processing circuit configured to:
interpret a bit sequence as a value based on one of a plurality of number formats as indicated by a bias mode indicator; and
perform an operation using the value.

2. The device of claim 1, wherein the bias mode indicator corresponds to a status bit.

3. The device of claim 2, wherein the status bit is hardware programmable.

4. The device of claim 2, wherein the status bit is dynamically adjustable via software.

5. The device of claim 1, further comprising a plurality of processing circuits that includes the processing circuit, wherein each of the plurality of processing circuits correspond to a respective one of the plurality of number formats.

6. The device of claim 1, wherein the processing circuit is configured to interpret an exponent using a bias in accordance with the corresponding number format and further based on the bias mode indicator.

7. The device of claim 1, wherein the processing circuit is configured to interpret special bit sequences as special values in accordance with the corresponding number format.

8. The device of claim 1, further comprising a set of instructions and a corresponding bias mode indicator for each of the plurality of number formats.

9. The device of claim 8, wherein each set of instructions is configured to interpret an exponent using a bias in accordance with the corresponding number format and further based on the corresponding bias mode indicator.

10. The device of claim 8, wherein each set of instructions is configured to interpret special bit sequences as special values in accordance with the corresponding number format.

11. The device of claim 1, wherein each of the plurality of number formats correspond to a floating point format.

12. The device of claim 11, wherein each of the floating point formats have a similar level of precision.

13. A system comprising:
a memory; and
a processing circuit configured with a set of instructions, wherein:
each instruction is configured to interpret a bit sequence read from the memory as a value based on one of a plurality of number formats as modified by a bias mode indicator; and
the processing circuit is configured to perform an operation using the value.

14. The system of claim 13, wherein the bias mode indicator is dynamically adjustable.

15. The system of claim 13, wherein the set of instructions is configured to interpret an exponent in accordance with the corresponding number format using a bias based on the bias mode indicator.

16. The system of claim 13, wherein each set of instructions is configured to interpret special bit sequences as special values in accordance with the corresponding number format using a bias based on the bias mode indicator.

17. The system of claim 13, wherein each of the plurality of number formats correspond to a floating point format, each of the floating point formats having a similar level of precision.

18. A method comprising:
receiving, as part of an operation, a bit sequence corresponding to a number format;
extracting a number element from the bit sequence based on the number format;
applying a bias to the extracted element based on a bias mode indicator to determine a value from the bit sequence; and
completing the operation using the determined value.

19. The method of claim 18, wherein the bias mode indicator is dynamically adjustable.

20. The method of claim 18, wherein the number format corresponds to a floating point format and the number element corresponds to an exponent.
